(19) United States
(12) Patent Application Publication
(10) Pub. No.: US 2023/0410204 A1
(43) Pub. Date: Dec. 21, 2023

(54) SYSTEM AND METHOD FOR IMPLEMENTING AN INTELLIGENT DATA PROCESSING MODULE

(71) Applicant: JPMorgan Chase Bank, N.A., New York, NY (US)

(72) Inventors: David CRACKNELL, Greenwich (GB); Dharmesh SHAH, New York, NY (US)

(73) Assignee: JPMorgan Chase Bank, N.A., New York, NY (US)

(21) Appl. No.: 17/807,212

(22) Filed: Jun. 16, 2022

(51) Int. Cl. G06Q 40/06; G06Q 40/04

(52) U.S. Cl. CPC G06Q 40/06; G06Q 40/04

(57) ABSTRACT

Various methods, apparatuses/systems, and media for data processing and analysis report generation are disclosed. A processor establishes a communication link between the processor and a system of record via a communication network. The system of record stores raw data corresponding to one or more trades. The processor receives the raw data from the system of record; analyzes the received raw data; identifies, in response to analyzing, revenue drivers data and revenue change drivers data in connection with the raw data corresponding to the one or more trades; decomposes revenue data by computing the revenue drivers data; decomposes the revenue data by computing the revenue change drivers data; generates, in response to decomposing, a custom GUI having a plurality of display screens; and displays an analysis report on data corresponding to the identified drivers data onto the plurality of display screens in a desired format.

### TECHNICAL FIELD

This disclosure generally relates to data processing, and, more particularly, to methods and apparatuses for implementing an intelligent data processing module for processing data and generating report.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Today, a wide variety of business functions are commonly supported by software applications and tools, i.e., business intelligence (BI) tools. For instance, software applications have directed to generate revenue data (i.e., profit and loss analysis data), performance analysis data, project tracking data, margin management workflow data, and competitive analysis data, to name but a few. In general, large enterprises, corporations, agencies, institutions, and other organizations are facing a continuing problem of handling, processing, and/or accurately describing a vast amount of data (often exceeding 450 PB) that are crucial to plan actions in an efficient and expedited manner. The stored data is often not in a centralized location, yet needs to be analyzed by a variety of persons within the organization to inform strategy, which may prove to be extremely time consuming, confusing, inaccurate, and inefficient for planning actions.

For example, revenue data has been a standard data-set for the agency securities lending business as it has been for all other businesses. However, this revenue data generated by the conventional tools is retrospective and effectively just shows revenue totals at various levels of granularity. These conventional tools fail to provide deeper analytical insight and visualizations to show the factors that drove the generation of the revenue. In addition, these conventional tools fail to provide a mechanism for tracking components of the revenue against forecasted revenue.

Therefore, there is a need for an advanced tool that can address these conventional shortcomings.

### SUMMARY

The present disclosure, through one or more of its various aspects, embodiments, and/or specific features or sub-components, provides, among other features, various systems, servers, devices, methods, media, programs, and platforms for implementing an intelligent data processing module configured for providing deeper analytical insight and visualizations to show the factors that drove generation of modified revenue data from raw data sets from a plurality of system of records as well as providing a mechanism for tracking components of the modified data against forecasted revenue data, but the disclosure is not limited thereto.

According to an aspect of the present disclosure, a method for data processing and automated report generation by utilizing one or more processors and one or more memories is disclosed. The method may include: establishing a communication link between a processor and a system of record via a communication network, wherein the system of record stores raw data corresponding to one or more trades; receiving the raw data from the system of record; analyzing the received raw data; identifying, in response to analyzing, revenue drivers data in connection with the raw data corresponding to the one or more trades; identifying, in response to analyzing, revenue change drivers data in connection with the raw data corresponding to one or more trades; decomposing revenue data by computing the revenue drivers data; decomposing the revenue data by computing the revenue change drivers data; generating, in response to decomposing, a custom graphical user interface (GUI) having a plurality of display screens; and displaying an analysis report on data corresponding to the identified drivers data onto the plurality of display screens in a desired format.

According to yet another aspect of the instant disclosure, the system of record may be an agency securities lending system, but the disclosure is not limited thereto.

According to a further aspect of the instant disclosure, the revenue drivers data may include one or more of the following data related to the one or more trades: intrinsic spread, reinvest rate, transfer pricing, administrative fee, cash management fee, bottom line adjustments, client level adjustments describing breakdown in revenue between an organization and its client, but the disclosure is not limited thereto.

According to yet another aspect of the instant disclosure, the revenue change drivers data may include one or more of the following data related to the one or more trades: intrinsic spread, reinvest rate, transfer pricing, administrative fee, cash management fee, bottom line adjustments, client level adjustments, quantity, yield enhancement, price, fee split, foreign exchange rate, time period, describing breakdown in revenue between an organization and its client, but the disclosure is not limited thereto.

According to an additional aspect of the instant disclosure, the plurality of display screens may include a first display screen, a second display screen, a third display screen, and a fourth display screen, in displaying the analysis report on the data, the method may further include: comparing actual revenue data against forecasted revenue data corresponding to the one or more trades and generating a comparison data; and displaying, in response to comparing, a predefined visual representation of the comparison data onto the fourth display screen.

According to yet another aspect of the instant disclosure, in displaying the analysis report on the data, the method may further include: identifying revenue drivers data, revenue change drivers data, and revenue trend data corresponding to the one or more trades; and displaying, in response to identifying, a predefined summary view of the revenue drivers data, revenue change drivers data, and revenue trend data onto the first display screen.

According to yet another aspect of the instant disclosure, in displaying the analysis report on the data, the method may further include: receiving user input data corresponding to a desired format to represent the identified revenue drivers data; and displaying, in response to receiving user input data, a visual representation of the identified revenue drivers data in the desired format onto the third display screen, but the disclosure is not limited thereto. For example, the visual representation of the identified revenue drivers data in the desired format may be displayed onto all display screens of the plurality of display screens.

According to a further aspect of the instant disclosure, the method may further include: tracking components of actual revenue data against predefined forecasted revenue data corresponding to the one or more trades.

According to another aspect of the instant disclosure, a system for data processing and automated report generation is disclosed. The system may include: a processor; and a memory operatively connected to the processor via a communication interface, the memory storing computer readable instructions, when executed, may cause the processor to: establish a communication link between a processor and a system of record via a communication network, wherein the system of record stores raw data corresponding to one or more trades; receive the raw data from the system of record; analyze the received raw data; identify, in response to analyzing, revenue drivers data in connection with the raw data corresponding to the one or more trades; identify, in response to analyzing, revenue change drivers data in connection with the raw data corresponding to one or more trades; decompose revenue data by computing the revenue drivers data; decompose the revenue data by computing the revenue change drivers data; generate, in response to decomposing, a custom GUI having a plurality of display screens; and display an analysis report on data corresponding to the identified drivers data onto the plurality of display screens in a desired format.

According to yet another aspect of the instant disclosure, the plurality of display screens may include a first display screen, a second display screen, a third display screen, and a fourth display screen, and in displaying the analysis report on the data, the processor may be further configured to: compare actual revenue data against forecasted revenue data corresponding to the one or more trades and generate a comparison data; and display, in response to comparing, a predefined visual representation of the comparison data onto the fourth display screen.

According to a further aspect of the instant disclosure, in displaying the analysis report on the data, the processor may be further configured to: identify revenue drivers data, revenue change drivers data, and revenue trend data corresponding to the one or more trades; and display, in response to identifying, a predefined summary view of the revenue drivers data, revenue change drivers data, and revenue trend data onto the first display screen.

According to yet another aspect of the instant disclosure, in displaying the analysis report on the data, the processor may be further configured to: receive user input data corresponding to a desired format to represent the identified revenue drivers data; and display, in response to receiving user input data, a visual representation of the identified revenue drivers data in the desired format onto the third display screen, but the disclosure is not limited thereto.

According to a further aspect of the present disclosure, the processor may be further configured to: track components of actual revenue data against predefined forecasted revenue data corresponding to the one or more trades.

According to yet another aspect of the present disclosure, a non-transitory computer readable medium configured to store instructions for data processing and automated report generation is disclosed. The instructions, when executed, cause a processor to perform the following: establishing a communication link between a processor and a system of record via a communication network, wherein the system of record stores raw data corresponding to one or more trades; receiving the raw data from the system of record; analyzing the received raw data; identifying, in response to analyzing, revenue drivers data in connection with the raw data corresponding to the one or more trades; identifying, in response to analyzing, revenue change drivers data in connection with the raw data corresponding to one or more trades; decomposing revenue data by computing the revenue drivers data; decomposing the revenue data by computing the revenue change drivers data; generating, in response to decomposing, a custom GUI having a plurality of display screens; and displaying an analysis report on data corresponding to the identified drivers data onto the plurality of display screens in a desired format.

According to an additional aspect of the instant disclosure, the plurality of display screens may include a first display screen, a second display screen, a third display screen, and a fourth display screen, and in displaying the analysis report on the data, the instructions, when executed, may further cause the processor to perform the following: comparing actual revenue data against forecasted revenue data corresponding to the one or more trades and generating a comparison data; and displaying, in response to comparing, a predefined visual representation of the comparison data onto the fourth display screen.

According to a further aspect of the instant disclosure, in displaying the analysis report on the data, the instructions, when executed, may further cause the processor to perform the following: identifying revenue drivers data, revenue change drivers data, and revenue trend data corresponding to the one or more trades; and displaying, in response to identifying, a predefined summary view of the revenue drivers data, revenue change drivers data, and revenue trend data onto the first display screen.

According to yet another aspect of the instant disclosure, in displaying the analysis report on the data, the instructions, when executed, may further cause the processor to perform the following: receiving user input data corresponding to a desired format to represent the identified revenue drivers data; and displaying, in response to receiving user input data, a visual representation of the identified revenue drivers data in the desired format onto the third display screen, but the disclosure is not limited thereto.

According to a further aspect of the instant disclosure, the instructions, when executed, may further cause the processor to perform the following: tracking components of actual revenue data against predefined forecasted revenue data corresponding to the one or more trades.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing an intelligent data processing module for in accordance with an exemplary embodiment.

FIG. 2 illustrates an exemplary diagram of a network environment with an intelligent data processing device in accordance with an exemplary embodiment.

FIG. 3 illustrates a system diagram for implementing an intelligent data processing device having an intelligent data processing module in accordance with an exemplary embodiment.

FIG. 4 illustrates a system diagram for implementing an intelligent data processing module of FIG. 3 in accordance with an exemplary embodiment.

FIG. 5 illustrates an exemplary graphical user interface implemented by the intelligent data processing module of FIG. 4 in accordance with an exemplary embodiment.

FIG. 6 illustrates a flow chart implemented by the intelligent data processing module of FIG. 4 in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

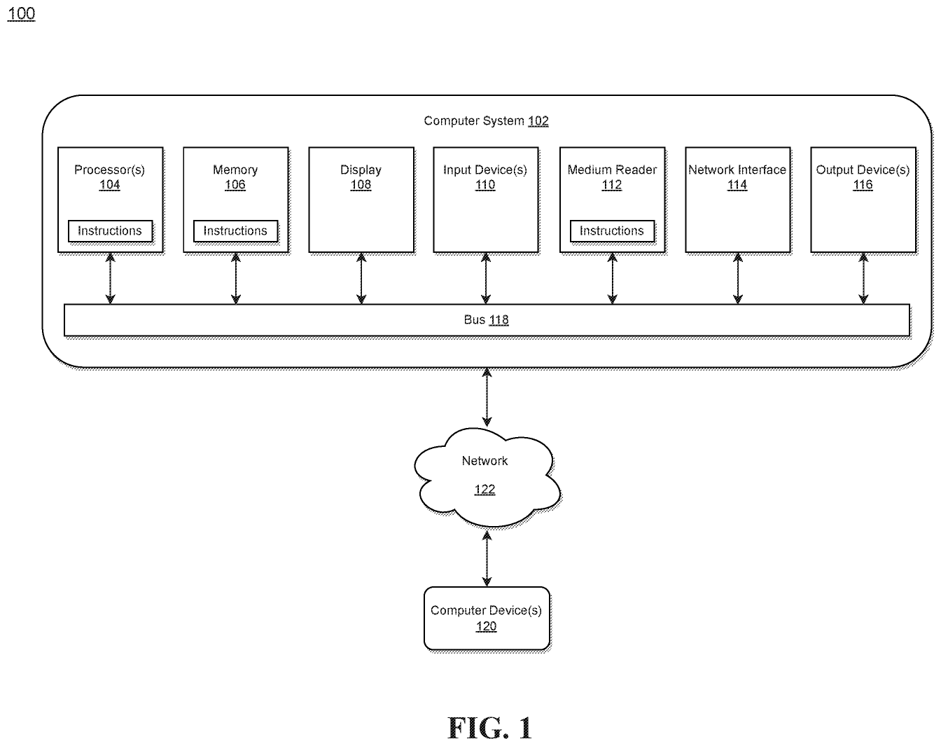

FIG. 1 is an exemplary system for use in implementing an intelligent data processing module configured for providing deeper analytical insight and visualizations to show the factors that drove generation of revenue as well as providing a mechanism for tracking components of the revenue against forecasted revenue data in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

According to exemplary embodiments, the intelligent data processing module may be platform and language agnostic that may allow for consistent easy orchestration and passing of data through various components to output a desired result. Since the disclosed process, according to exemplary embodiments, is platform and language agnostic, the intelligent data processing module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

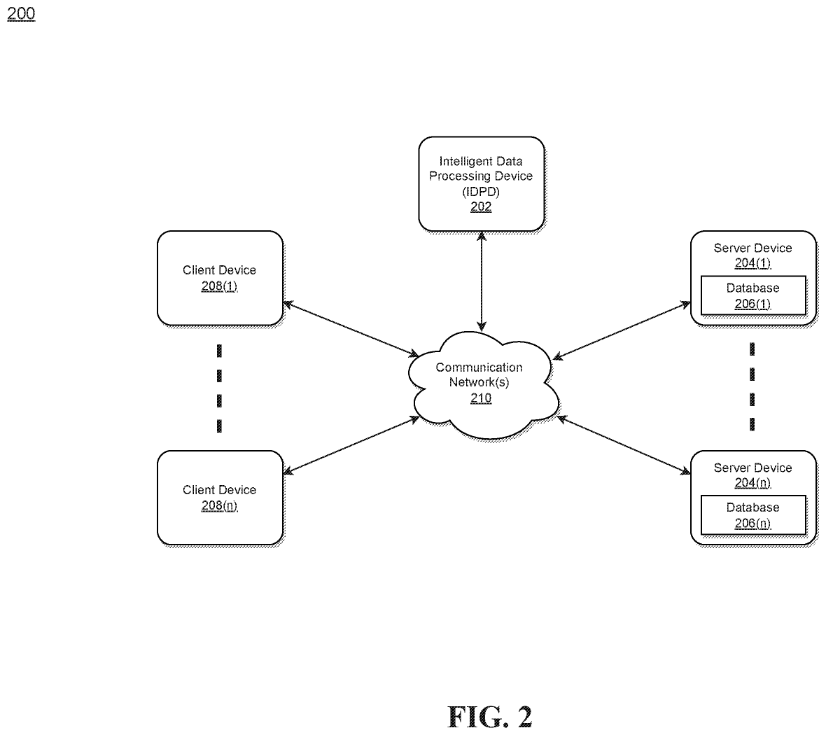

Referring to FIG. 2, a schematic of an exemplary network environment 200 for implementing an intelligent data processing device (IDPD) of the instant disclosure is illustrated.

According to exemplary embodiments, the above-described problems associated with conventional data processing tools may be overcome by implementing an IDPD 202 as illustrated in FIG. 2 that may be configured for providing deeper analytical insight and visualizations to show the factors that drove generation of modified revenue data from raw data sets from a plurality of system of records as well as providing a mechanism for tracking components of the modified revenue data against forecasted revenue data, thereby configuring an advanced GUI tool that allows for decision making advantage compared to conventional tools as senior business managers are able to ask more advanced questions of their data based on displayed consolidated data, but the disclosure is not limited thereto.

The IDPD 202 may be the same or similar to the computer system 102 as described with respect to FIG. 1.

The IDPD 202 may store one or more applications that can include executable instructions that, when executed by the IDPD 202, cause the IDPD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the IDPD 202 itself, may be located in virtual server(s) running in a cloud-based computing environment rather than being tied to one or more specific physical network computing devices. Also, the application(s) may be running in one or more virtual machines (VMs) executing on the IDPD 202. Additionally, in one or more embodiments of this technology, virtual machine(s) running on the IDPD 202 may be managed or supervised by a hypervisor.

In the network environment 200 of FIG. 2, the IDPD 202 is coupled to a plurality of server devices 204(1)-204(n) that hosts a plurality of databases 206(1)-206(n), and also to a plurality of client devices 208(1)-208(n) via communication network(s) 210. A communication interface of the IDPD 202, such as the network interface 114 of the computer system 102 of FIG. 1, operatively couples and communicates between the IDPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IDPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The IDPD 202 may be a standalone device or integrated with one or more other devices or apparatuses, such as one or more of the server devices 204(1)-204(n), for example. In one particular example, the IDPD 202 may be hosted by one of the server devices 204(1)-204(n), and other arrangements are also possible. Moreover, one or more of the devices of the IDPD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the IDPD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the IDPD 202 that may efficiently provide a platform for providing deeper analytical insight and visualizations to show the factors that drove generation of modified revenue data from raw data sets from a plurality of system of records as well as providing a mechanism for tracking components of the modified revenue data against forecasted revenue data, thereby configuring an advanced GUI tool that allows for decision making advantage compared to conventional tools as senior business managers are able to ask more advanced questions of their data based on displayed consolidated data, but the disclosure is not limited thereto.

The client devices 208(1)-208(n) may run interface applications, such as standard web browsers or standalone client applications, which may provide an interface to communicate with the IDPD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the IDPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the IDPD 202, the server devices 204(1)-204(n), or the client devices 208(1)-208(n), for example, may be configured to operate as virtual instances on the same physical machine. For example, one or more of the IDPD 202, the server devices 204(1)-204(n), or the client devices 208(1)-208(n) may operate on the same physical device rather than as separate devices communicating through communication network(s) 210. Additionally, there may be more or fewer IDPDs 202, server devices 204(1)-204(n), or client devices 208(1)-208(n) than illustrated in FIG. 2. According to exemplary embodiments, the IDPD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

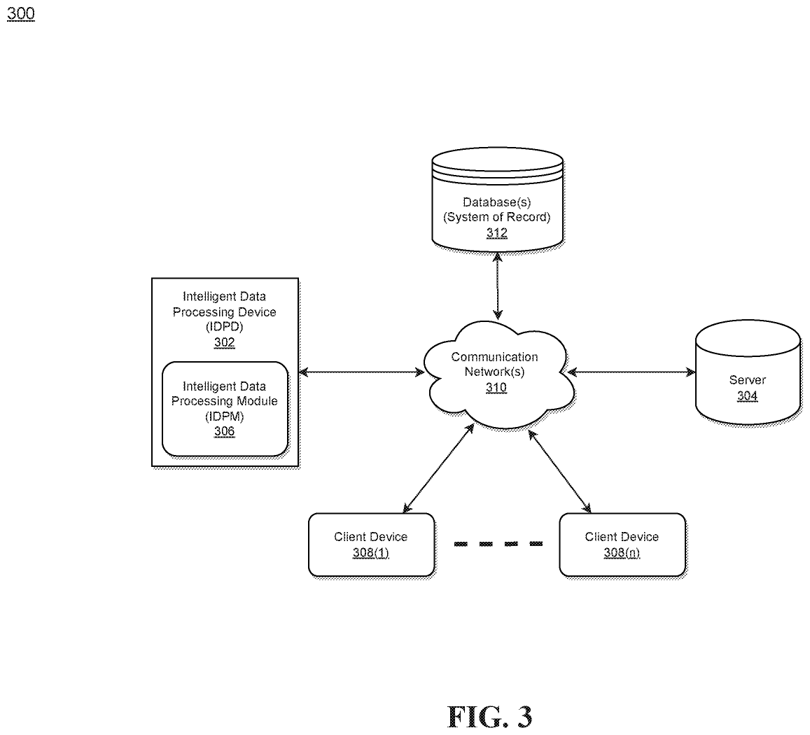

FIG. 3 illustrates a system diagram for implementing an IDPD having an intelligent data processing module (IDPM) in accordance with an exemplary embodiment.

As illustrated in FIG. 3, the system 300 may include an IDPD 302 within which an IDPM 306 is embedded, a server 304, a database(s) 312, a plurality of client devices 308(1) . . . 308(n), and a communication network 310. The database(s) 312 may include a system of record for agency securities lending system.

According to exemplary embodiments, the IDPD 302 including the IDPM 306 may be connected to the server 304, and the database(s) 312 via the communication network 310. The IDPD 302 may also be connected to the plurality of client devices 308(1) . . . 308(n) via the communication network 310, but the disclosure is not limited thereto.

According to exemplary embodiment, the IDPD 302 is described and shown in FIG. 3 as including the IDPM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein.

According to exemplary embodiments, the IDPM 306 may be configured to receive real-time feed of data from the plurality of client devices 308(1) . . . 308(n) and the database(s) via the communication network 310.

As will be described below, the IDPM 306 may be configured to establish a communication link between a processor and a system of record via a communication network, wherein the system of record stores raw data corresponding to one or more trades; receive the raw data from the system of record; analyze the received raw data; identify, in response to analyzing, revenue drivers data in connection with the raw data corresponding to the one or more trades; identify, in response to analyzing, revenue change drivers data in connection with the raw data corresponding to one or more trades; decompose revenue data by computing the revenue drivers data; decompose the revenue data by computing the revenue change drivers data; generate, in response to decomposing, a custom GUI having a plurality of display screens; and display an analysis report on data corresponding to the identified drivers data onto the plurality of display screens in a desired format, but the disclosure is not limited thereto.

The plurality of client devices 308(1) . . . 308(n) are illustrated as being in communication with the IDPD 302. In this regard, the plurality of client devices 308(1) . . . 308(n) may be “clients” of the IDPD 302 and are described herein as such. Nevertheless, it is to be known and understood that the plurality of client devices 308(1) . . . 308(n) need not necessarily be “clients” of the IDPD 302, or any entity described in association therewith herein. Any additional or alternative relationship may exist between either or both of the plurality of client devices 308(1) . . . 308(n) and the IDPD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the IDPD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The IDPD 302 may be the same or similar to the IDPD 202 as described with respect to FIG. 2, including any features or combination of features described with respect thereto.

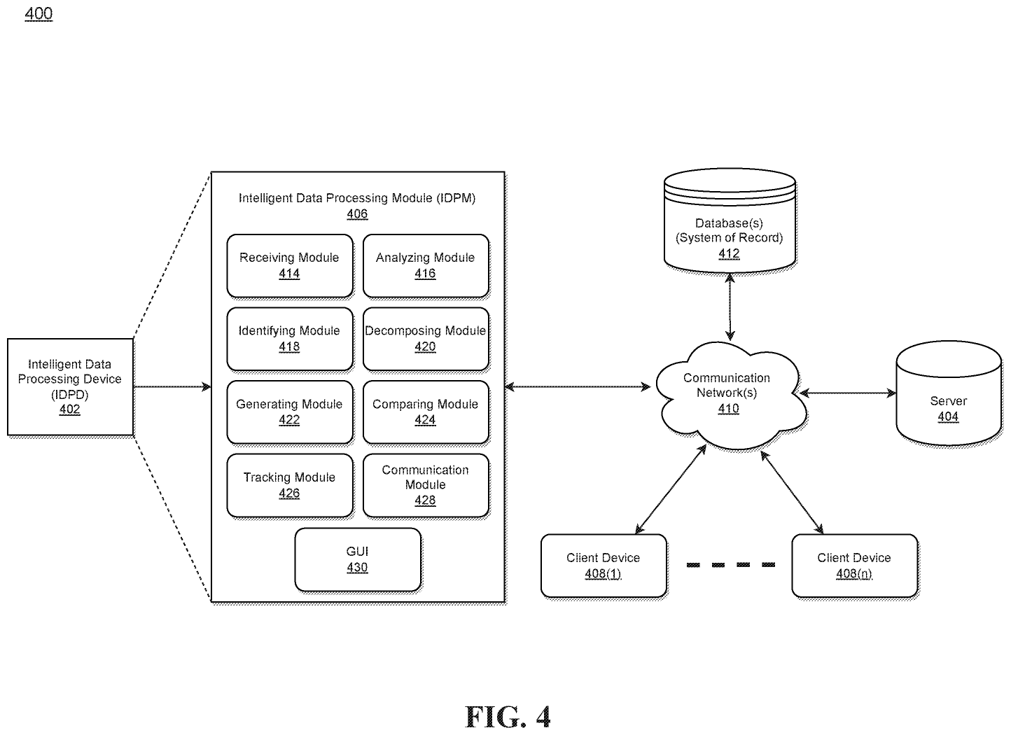

FIG. 4 illustrates a system diagram for implementing an IDPM of FIG. 3 in accordance with an exemplary embodiment.

According to exemplary embodiments, the system 400 may include an IDPD 402 within which an IDPM 406 is embedded, a server 404, database(s) 412, and a communication network 410. The database(s) 412 may include a system of record for agency securities lending system to provide raw data corresponding to one or more trades.

According to exemplary embodiments, the IDPD 402 including the IDPM 406 may be connected to the server 404 and the database(s) 412 via the communication network 410. The IDPD 402 may also be connected to the plurality of client devices 408(1)-408(n) via the communication network 410, but the disclosure is not limited thereto. The IDPM 406, the server 404, the plurality of client devices 408(1)-408(n), the database(s) 412, the communication network 410 as illustrated in FIG. 4 may be the same or similar to the IDPM 306, the server 304, the plurality of client devices 308(1)-308(n), the database(s) 312, the communication network 310, respectively, as illustrated in FIG. 3.

According to exemplary embodiments, as illustrated in FIG. 4, the IDPM 406 may include a receiving module 414, an analyzing module 416, an identifying module 418, a decomposing module 420, a generating module 422, a comparing module 424, a tracking module 426, a communication module 428, and a GUI 430.

According to exemplary embodiments, each of the receiving module 414, analyzing module 416, identifying module 418, decomposing module 420, generating module 422, comparing module 424, tracking module 426, and the communication module 428 of the IDPM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the receiving module 414, analyzing module 416, identifying module 418, decomposing module 420, generating module 422, comparing module 424, tracking module 426, and the communication module 428 of the IDPM 406 may be implemented by microprocessors or similar, and may be programmed using software (e.g., microcode) to perform various functions discussed herein and may optionally be driven by firmware and/or software.

Alternatively, according to exemplary embodiments, each of the receiving module 414, analyzing module 416, identifying module 418, decomposing module 420, generating module 422, comparing module 424, tracking module 426, and the communication module 428 of the IDPM 406 may be implemented by dedicated hardware, or as a combination of dedicated hardware to perform some functions and a processor (e.g., one or more programmed microprocessors and associated circuitry) to perform other functions.

According to exemplary embodiments, each of the receiving module 414, analyzing module 416, identifying module 418, decomposing module 420, generating module 422, comparing module 424, tracking module 426, and the communication module 428 of the IDPM 406 may be called via corresponding API.

The process may be executed via the communication module 428 and the communication network 410, which may comprise plural networks as described above. For example, in an exemplary embodiment, the various components of the IDPM 406 may communicate with the server 404, and the database(s) 412 via the communication module 420 and the communication network 410. Of course, these embodiments are merely exemplary and are not limiting or exhaustive.

According to exemplary embodiments, the communication network 410 and the communication module 428 may be configured to establish a link between the database(s) 412, the client devices 408(1)-408(n) and the IDPM 406.

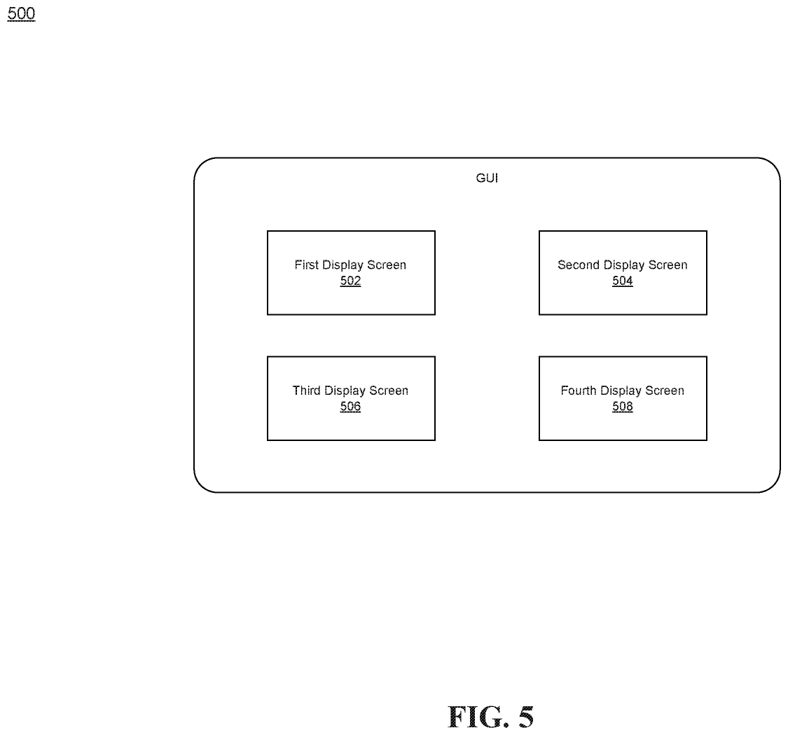

FIG. 5 illustrates an exemplary GUI 500 implemented by the IDPM 406 of FIG. 4 in accordance with an exemplary embodiment. As illustrated in FIG. 5, the GUI 500 may include a first display screen 502, a second display screen 504, a third display screen 506, and a fourth display screen 508, but the disclosure is not limited thereto. For example, the GUI 500 may include more than four display screens.

Referring to FIGS. 4 and 5, according to exemplary embodiments, the communication module 428 may be configured to establish a communication link between a processor (within the IDPM 406 or within the IDPD 402) and a system of record (i.e., within the database(s) 412 via the communication network 410. The system of record may store raw data corresponding to one or more trades. According to exemplary embodiments, the system of record within the database(s) 412 may be an agency securities lending system, but the disclosure is not limited thereto.

According to exemplary embodiments, a plurality of system of records may be provided for at least the following raw data sets, but the disclosure is not limited thereto: daily revenue data at the loan level; daily revenue adjustments data at the loan level; cash reinvestment data; benchmark market rates data; loan level revenue adjustments data; and client level revenue adjustments data.

According to exemplary embodiments, the receiving module 414 may be configured to receive the raw data sets from the system of records. The analyzing module 416 may be configured to analyze the received raw data sets. The identifying module 418 may be configured to identify, in response to analyzing, revenue drivers data in connection with the raw data corresponding to the one or more trades. The identifying module 418 may further be configured to identify, in response to analyzing, revenue change drivers data in connection with the raw data corresponding to the one or more trades. The decomposing module 420 may be configured to decompose revenue data by computing the revenue drivers data. The decomposing module 420 may further be configured to decompose the revenue data by computing the revenue change drivers data. The generating module 422 may be configured to generate, in response to decomposing, a custom GUI (i.e., GUI 430 as illustrated in FIG. 4 or the GUI 500 as illustrated in FIG. 5) having at least a first display screen 502, a second display screen 504, a third display screen 506, and a fourth display screen, but the disclosure is not limited thereto. The GUI 430, 500 may be configured to display an analysis report on data corresponding to the identified drivers data onto the display screens 502, 504, 506, 508 in a desired format.

According to exemplary embodiments, the revenue drivers data may include one or more of the following data related to the one or more trades: intrinsic spread, reinvest rate, transfer pricing, administrative fee, cash management fee, bottom line adjustments, client level adjustments describing breakdown in revenue between an organization and its client, but the disclosure is not limited thereto.

According to exemplary embodiments, the revenue change drivers data may include one or more of the following data related to the one or more trades: intrinsic spread, reinvest rate, transfer pricing, administrative fee, cash management fee, bottom line adjustments, client level adjustments, quantity, yield enhancement, price, fee split, foreign exchange rate, time period, describing breakdown in revenue between an organization and its client, but the disclosure is not limited thereto.

For example, according to exemplary embodiments, the IDPM 406 may be configured to merge all of datasets received from the system of records at the right level of granularity in order to carry out further analysis.

The IDPM 406 then goes through a data analysis process to derive and compute the following revenue drivers data, but the disclosure is not limited thereto.

For example, according to exemplary embodiments, the IDPM 406 may implement a data analysis process to derive and compute intrinsic spread data. The intrinsic spread data is revenue data generated as a result of the intrinsic value of the lent asset. For loans booked versus cash collateral, this may prove to be the risk-free re-investment rate, less the actual rebate rate.

According to exemplary embodiments, the IDPM 406 may implement a data analysis process to derive and compute reinvest rate data. The reinvest rate data is revenue data generated as a result of any cash re-investment activity and calculated as actual re-investment rate, less risk-free reinvestment rate, less transfer pricing.

According to exemplary embodiments, the IDPM 406 may implement a data analysis process to derive and compute transfer pricing data. The transfer pricing data is revenue data generated as a result of loan transactions where actual rebate on the loan is greater than the risk-free benchmark re-investment rate.

According to exemplary embodiments, the IDPM 406 may implement a data analysis process to derive and compute administrative fee data. The administrative fee data is revenue data generated as a result of fees levied against the beneficial owner.

According to exemplary embodiments, the IDPM 406 may implement a data analysis process to derive and compute cash management fee data. The cash management fee data is revenue data generated as a result of cash management fee levied on cash collateral balances.

According to exemplary embodiments, the IDPM 406 may implement a data analysis process to derive and compute the Bottom Line Adjustments data. The Bottom Line Adjustments data is the revenue data generated as a result of Bottom Line Adjustments.

According to exemplary embodiments, the IDPM 406 may implement a data analysis process to derive and compute the Client Level Adjustments data. The Client Level Adjustments data is the revenue data generated as a result of Client Level Adjustments.

According to exemplary embodiments, the IDPM 406 may implement further data analysis process to derive and compute quantity data. The quantity data is revenue data generated as a result of a change in the quantity of financial securities being out on loan (new loans/returns).

According to exemplary embodiments, the IDPM 406 may implement a data analysis process to derive and compute yield enhancement data. The yield enhancement data is revenue data generated as a result of yield enhancement and one-day re-rate trades.

According to exemplary embodiments, the IDPM 406 may implement a data analysis process to derive and compute price data. The price data is revenue data generated as a result of a change in the asset price which is ultimately used for billing.

According to exemplary embodiments, the IDPM 406 may implement a data analysis process to derive and compute fee split data. The fee split data is revenue data generated as a result of a change of a true client reprice or a change in the agreed dynamic fee split in line with the basis points of the loan.

According to exemplary embodiments, the IDPM 406 may implement a data analysis process to derive and compute foreign exchange rate data. The foreign exchange rate data is revenue data generated as a result of a change in the foreign exchange rate used to convert non-U.S. dollar revenue to U.S. dollar revenue.

According to exemplary embodiments, the IDPM 406 may implement a data analysis process to derive and compute time period data. The time period data is revenue data generated as a result of the two time periods being compared having a different number of calendar days. According to exemplary embodiments, it may appear if Month to Date, Quarter to Date or Year to Date selections are made.

Referring back to FIGS. 4 and 5, according to exemplary embodiments, in displaying the analysis report on the data, the GUI 430, 500 may be further configured to: compare actual revenue data against forecasted revenue data corresponding to the one or more trades and generate a comparison data; and display, in response to comparing, a predefined visual representation of the comparison data onto the fourth display screen 508.

For example, according to exemplary embodiments, the IDPM 406 may aggregate the new data elements so obtained in the above-described process to reflect on the first display screen 502. According to exemplary embodiments, the first display screen 502 may display the following data, but the disclosure is not limited thereto: revenue drivers data; revenue change drivers data; and revenue trend data. Types of revenue data may include, but not limited thereto: Bank Revenue, Client Revenue, Total Revenue. The time frame may include: Daily, Month to Date, Quarter to Date, Year to Date, but the disclosure is not limited thereto.

According to exemplary embodiments, in displaying the analysis report on the data, the GUI 430, 500 may be further configured to: identify revenue drivers data, revenue change drivers data, and revenue trend data corresponding to the one or more trades; and display, in response to identifying, a predefined summary view of the revenue drivers data, revenue change drivers data, and revenue trend data onto the first display screen 502.

For example, according to exemplary embodiments, the IDPM 406 may also aggregate the new data elements so obtained in the above-described process to reflect on the second display screen 504. According to exemplary embodiments, the second display screen 504 may display the following data, but the disclosure is not limited thereto: daily revenue data, daily drivers data, revenue drivers day over day difference data with the ability to dissect the data by: Asset attributes, Borrower attributes, Collateral Currency, Collateral Schedule, Collateral Type, Country of Issue, Country of Risk, Country of Trade, Desk Asset Class, Contract Entity, Lender attributes, Lending Market Region, Location Held, Security attributes, Trade Type, Bottom Line Adjustments, Client Level Adjustments. According to exemplary embodiments, types of revenue data may include, but the disclosure is not limited thereto: Bank Revenue, Client Revenue, Total Revenue. The time frame include daily.

According to exemplary embodiments, in displaying the analysis report on the data, the GUI 430, 500 may be further configured to: receive user input data corresponding to a desired format to represent the identified revenue drivers data; and display, in response to receiving user input data, a visual representation of the identified revenue drivers data in the desired format onto the third display screen 506, but the disclosure is not limited thereto. For example, the visual representation of the identified revenue drivers data in the desired format may be displayed onto the first display screen 502, second display screen 504, third display screen 506, and the fourth display screen 508, or alternatively, any one of the display screens of the plurality of display screens.

For example, according to exemplary embodiments, the IDPM 406 may also aggregate the new data elements so obtained in the above-described process to reflect on the third display screen 506. According to exemplary embodiments, the third display screen 506 may display the following data, but the disclosure is not limited thereto: Month to Date revenue data, Month to Date revenue drivers data with the ability to dissect the data by: Asset attributes, Borrower attributes, Collateral Currency, Collateral Schedule, Collateral Type, Country of Issue, Country of Risk, Country of Trade, Desk Asset Class, Contract Entity, Lender attributes, Lending Market Region, Location Held, Security attributes, Trade Type, Bottom Line Adjustments, Client Level Adjustments.

According to exemplary embodiments, in displaying the analysis report on the data, the GUI 430, 500 may be further configured to: receive user input data corresponding to a desired format to represent the program level view data; and display, in response to receiving user input data, a visual representation of the program level view data in the desired format onto the plurality of screens.

According to exemplary embodiments, the IDPM 406 may also aggregate the new data elements so obtained in the above-described process to reflect on the fourth display screen 508. According to exemplary embodiments, the fourth display screen 508 may display the following data, but the disclosure is not limited thereto: program level view of the actual revenue data vs forecasted revenue data compared by Loan Balances, Spreads, Gross Revenue, Net Revenue, Split; program level view of the actual revenue data vs mid-year forecasted revenue data compared by Loan Balances, Spreads, Gross Revenue, Net Revenue, Split; program level view of the actual revenue vs prior year revenue compared by Loan Balances, Spreads, Gross Revenue, Net Revenue, Split. The time frames may include, but not limited thereto: Daily, Month to Date, Quarter to Date, Year to Date.

According to exemplary embodiments, the fourth display screen 508 may also display trend of actual revenue data vs forecasted revenue data vs prior year revenue data; Daily/Month to Date/Quarter to Date/Year to Date revenue variances data vs forecasted revenue data; Daily/Month to Date/Quarter to Date/Year to Date revenue data as a percentage of forecasted revenue data; Daily/Month to Date/Quarter to Date/Year to Date revenue variances data vs prior year revenue data.

According to exemplary embodiments, displayed data may be broken down by: Desk Asset Class, Collateral Type, Lending Market, Lender Region, etc., but the disclosure is not limited thereto.

According to exemplary embodiments, the tracking module 426 may be further configured to track components of the actual revenue data against predefined forecasted revenue data corresponding to the one or more trades.

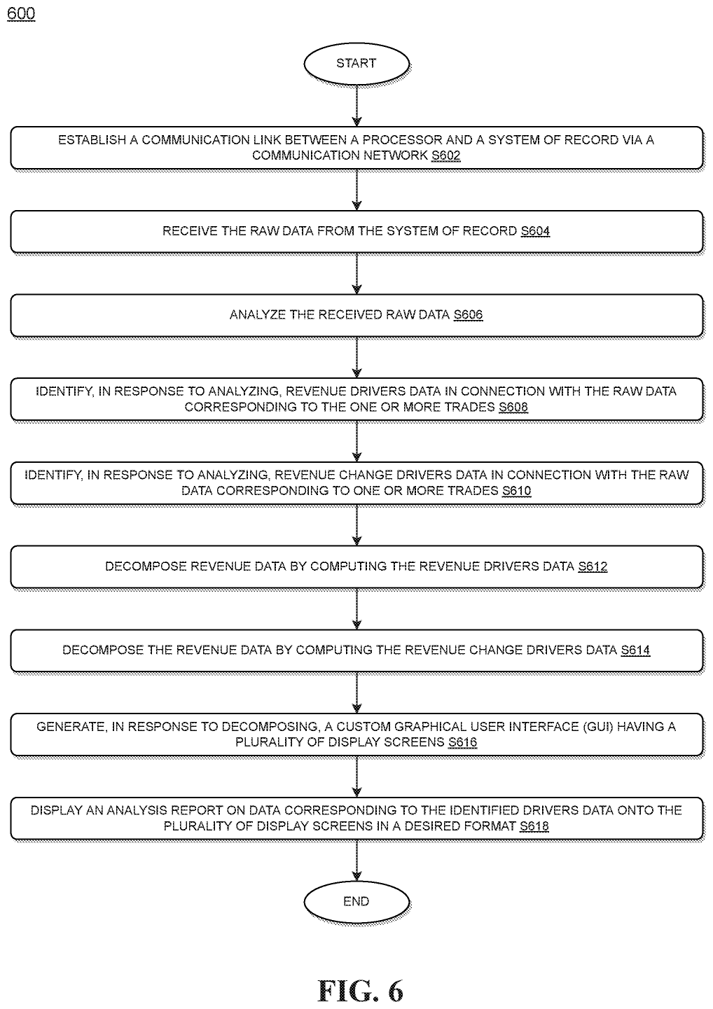

FIG. 6 illustrates a flow chart 600 implemented by the IDPM 406 of FIG. 4 for providing deeper analytical insight and visualizations to show the factors that drove generation of data as well as providing a mechanism for tracking components of the data against forecasted revenue data in accordance with an exemplary embodiment. It will be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include establishing a communication link between a processor and a system of record via a communication network. The system of record may store raw data corresponding to one or more trades.

At step S604, the process 600 may include receiving the raw data from the system of record.

At step S606, the process 600 may include analyzing the received raw data.

At step S608, the process 600 may include identifying, in response to analyzing, revenue drivers data in connection with the raw data corresponding to the one or more trades.

At step S610, the process 600 may include identifying, in response to analyzing, revenue change drivers data in connection with the raw data corresponding to one or more trades.

At step S612, the process 600 may include decomposing revenue data by computing the revenue drivers data.

At step S614, the process 600 may include decomposing the revenue data by computing the revenue change drivers data.

At step S616, the process 600 may include generating, in response to decomposing, a custom GUI having at least a first display screen, a second display screen, a third display screen, and a fourth display screen, but the disclosure is not limited thereto. Any number of desired screens may be utilized to display data.

At step S618, the process 600 may include displaying an analysis report on data corresponding to the identified drivers data onto the display screens in a desired format.

According to exemplary embodiments, in displaying the analysis report on the data, the process 500 may further include: comparing actual revenue data against forecasted revenue data corresponding to the one or more trades and generating a comparison data; and displaying, in response to comparing, a predefined visual representation of the comparison data onto the fourth display screen.

According to exemplary embodiments, in displaying the analysis report on the data, the process 500 may further include: identifying revenue drivers data, revenue change drivers data, and revenue trend data corresponding to the one or more trades; and displaying, in response to identifying, a predefined summary view of the revenue drivers data, revenue change drivers data, and revenue trend data onto the first display screen.

According to exemplary embodiments, in displaying the analysis report on the data, the process 500 may further include: receiving user input data corresponding to a desired format to represent the identified revenue drivers data; and displaying, in response to receiving user input data, a visual representation of the identified revenue drivers data in the desired format onto the third display screen, but the disclosure is not limited thereto. For example, the process 500 may display the visual representation of the identified revenue drivers data in the desired format onto all display screens of the plurality of display screens, or any combination thereof.

According to exemplary embodiments, in displaying the analysis report on the data, the process 500 may further include: receiving user input data corresponding to a desired format to represent the identified drivers data; and displaying, in response to receiving user input data, a visual representation of the program level view data in the desired format onto the plurality of display screens.

According to exemplary embodiments, the process 500 may further include: tracking components of the actual revenue data against predefined forecasted revenue data corresponding to the one or more trades.

According to exemplary embodiments, the IDPD 402 may include a memory (e.g., a memory 106 as illustrated in FIG. 1) which may be a non-transitory computer readable medium that may be configured to store instructions for implementing an IDPM 406 for data processing and automated report generation as disclosed herein. The IDPD 402 may also include a medium reader (e.g., a medium reader 112 as illustrated in FIG. 1) which may be configured to read any one or more sets of instructions, e.g., software, from any of the memories described herein. The instructions, when executed by a processor embedded within the IDPM 406 or within the IDPD 402, may be used to perform one or more of the methods and processes as described herein. In a particular embodiment, the instructions may reside completely, or at least partially, within the memory 106, the medium reader 112, and/or the processor 104 (see FIG. 1) during execution by the IDPD 402.

According to exemplary embodiments, the instructions, when executed, may cause a processor embedded within the IDPM 406 or the IDPD 402 to perform the following: establishing a communication link between a processor and a system of record via a communication network, wherein the system of record stores raw data corresponding to one or more trades; receiving the raw data from the system of record; analyzing the received raw data; identifying, in response to analyzing, revenue drivers data in connection with the raw data corresponding to the one or more trades; identifying, in response to analyzing, revenue change drivers data in connection with the raw data corresponding to one or more trades; decomposing revenue data by computing the revenue drivers data; decomposing the revenue data by computing the revenue change drivers data; generating, in response to decomposing, a custom GUI having a plurality of display screens; and displaying an analysis report on data corresponding to the identified drivers data onto the plurality of display screens in a desired format. The processor may be the same or similar to the processor 104 as illustrated in FIG. 1 or the processor embedded within IDPD 202, IDPD 302, IDPD 402, and IDPM 406.

According to exemplary embodiments, in displaying the analysis report on the data, the instructions, when executed, may further cause the processor 104 to perform the following: comparing actual revenue data against forecasted revenue data corresponding to the one or more trades and generating a comparison data; and displaying, in response to comparing, a predefined visual representation of the comparison data onto the fourth display screen.

According to exemplary embodiments, in displaying the analysis report on the data, the instructions, when executed, may further cause the processor 104 to perform the following: identifying revenue drivers data, revenue change drivers data, and revenue trend data corresponding to the one or more trades; and displaying, in response to identifying, a predefined summary view of the revenue drivers data, revenue change drivers data, and revenue trend data onto the first display screen.

According to exemplary embodiments, in displaying the analysis report on the data, the instructions, when executed, may further cause the processor 104 to perform the following: receiving user input data corresponding to a desired format to represent the identified revenue drivers data; and displaying, in response to receiving user input data, a visual representation of the identified revenue drivers data in the desired format onto the third display screen, but the disclosure is not limited thereto. For example, the instructions, when executed, may further cause the processor 104 to perform the following: displaying the visual representation of the identified revenue drivers data in the desired format onto all display screens of the plurality of display screens, or any combination thereof.

According to exemplary embodiments, in displaying the analysis report on the data, the instructions, when executed, may further cause the processor 104 to perform the following: receiving user input data corresponding to a desired format to represent the identified drivers data; and displaying, in response to receiving user input data, a visual representation of the program level view data in the desired format onto the fourth display screen.

According to exemplary embodiments, the instructions, when executed, may further cause the processor 104 to perform the following: tracking components of the revenue data against predefined forecasted revenue data corresponding to the one or more trades.

According to exemplary embodiments as disclosed above in FIGS. 1-6, technical improvements effected by the instant disclosure may include a platform for implementing an intelligent data processing module for providing deeper analytical insight and visualizations to show the factors that drove generation of modified revenue data from raw data sets from a plurality of system of records as well as providing a mechanism for tracking components of the actual revenue data against forecasted revenue data, thereby configuring an advanced GUI tool that allows for decision making advantage compared to conventional tools as senior business managers are able to ask more advanced questions of their data based on displayed consolidated data, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for data processing by utilizing one or more processors and one or more memories, the method comprising:
establishing a communication link between a processor and a system of record via a communication network, wherein the system of record stores raw data corresponding to one or more trades;
receiving the raw data from the system of record;
analyzing the received raw data;
identifying, in response to analyzing, revenue drivers data in connection with the raw data corresponding to the one or more trades;
identifying, in response to analyzing, revenue change drivers data in connection with the raw data corresponding to one or more trades;
decomposing revenue data by computing the revenue drivers data;
decomposing the revenue data by computing the revenue change drivers data;
generating, in response to decomposing, a custom graphical user interface (GUI) having a plurality of display screens; and
displaying an analysis report on data corresponding to the identified drivers data onto the plurality of display screens in a desired format.

2. The method according to claim 1, wherein the system of record is an agency securities lending system.

3. The method according to claim 1, wherein the revenue drivers data includes one or more of the following data related to the one or more trades: intrinsic spread, reinvest rate, transfer pricing, administrative fee, cash management fee, bottom line adjustments, client level adjustments describing breakdown in revenue between an organization and its client.

4. The method according to claim 1, wherein the revenue change drivers data includes one or more of the following data related to the one or more trades: intrinsic spread, reinvest rate, transfer pricing, administrative fee, cash management fee, bottom line adjustments, client level adjustments, quantity, yield enhancement, price, fee split, foreign exchange rate, time period, describing breakdown in revenue between an organization and its client.

5. The method according to claim 1, wherein the plurality of display screens include a first display screen, a second display screen, a third display screen, and a fourth display screen.

6. The method according to claim 5, wherein in displaying the analysis report on the data, the method further comprising:
comparing actual revenue data against forecasted revenue data corresponding to the one or more trades and generating a comparison data; and
displaying, in response to comparing, a predefined visual representation of the comparison data onto the fourth display screen.

7. The method according to claim 5, wherein in displaying the analysis report on the data, the method further comprising:
identifying revenue drivers data, revenue change drivers data, and revenue trend data corresponding to the one or more trades; and
displaying, in response to identifying, a predefined summary view of the revenue drivers data, revenue change drivers data, and revenue trend data onto the first display screen among the plurality of display screens.

8. The method according to claim 5, wherein in displaying the analysis report on the data, the method further comprising:
receiving user input data corresponding to a desired format to represent the identified revenue drivers data; and
displaying, in response to receiving user input data, a visual representation of the identified revenue drivers data in the desired format onto the third display screen.

9. The method according to claim 1, further comprising:
tracking components of actual revenue data against predefined forecasted revenue data corresponding to the one or more trades.

10. A system for data processing, the system comprising:
a processor; and
a memory operatively connected to the processor via a communication interface, the memory storing computer readable instructions, when executed, causes the processor to:
establish a communication link between a processor and a system of record via a communication network, wherein the system of record stores raw data corresponding to one or more trades;
receive the raw data from the system of record;
analyze the received raw data;
identify, in response to analyzing, revenue drivers data in connection with the raw data corresponding to the one or more trades;
identify, in response to analyzing, revenue change drivers data in connection with the raw data corresponding to one or more trades;
decompose revenue data by computing the revenue drivers data;
decompose the revenue data by computing the revenue change drivers data;
generate, in response to decomposing, a custom graphical user interface (GUI) having a plurality of display screens; and
display an analysis report on data corresponding to the identified drivers data onto the plurality of display screens in a desired format.

11. The system according to claim 10, wherein the system of record is an agency securities lending system.

12. The system according to claim 10, wherein the revenue drivers data includes one or more of the following data related to the one or more trades: intrinsic spread, reinvest rate, transfer pricing, administrative fee, cash management fee, bottom line adjustments, client level adjustments describing breakdown in revenue between an organization and its client.

13. The system according to claim 10, wherein the revenue change drivers data includes one or more of the following data related to the one or more trades: intrinsic spread, reinvest rate, transfer pricing, administrative fee, cash management fee, bottom line adjustments, client level adjustments, quantity, yield enhancement, price, fee split, foreign exchange rate, time period, describing breakdown in revenue between an organization and its client.

14. The system according to claim 10, wherein the plurality of display screens include a first display screen, a second display screen, a third display screen, and a fourth display screen.

15. The system according to claim 14, wherein in displaying the analysis report on the data, the processor is further configured to:
compare actual revenue data against forecasted revenue data corresponding to the one or more trades and generate a comparison data; and
display, in response to comparing, a predefined visual representation of the comparison data onto the fourth display screen.

16. The system according to claim 14, wherein in displaying the analysis report on the data, the processor is further configured to:
identify revenue drivers data, revenue change drivers data, and revenue trend data corresponding to the one or more trades; and
display, in response to identifying, a predefined summary view of the revenue drivers data, revenue change drivers data, and revenue trend data onto the first display screen.

17. The system according to claim 14, wherein in displaying the analysis report on the data, the processor is further configured to:
receive user input data corresponding to a desired format to represent the identified revenue drivers data; and
display, in response to receiving user input data, a visual representation of the identified revenue drivers data in the desired format onto the third display screen.

18. The system according to claim 10, the processor is further configured to:
track components of actual revenue data against predefined forecasted revenue data corresponding to the one or more trades.

19. A non-transitory computer readable medium configured to store instructions for data processing, wherein, when executed, the instructions cause a processor to perform the following:
establishing a communication link between a processor and a system of record via a communication network, wherein the system of record stores raw data corresponding to one or more trades;
receiving the raw data from the system of record;
analyzing the received raw data;
identifying, in response to analyzing, revenue drivers data in connection with the raw data corresponding to the one or more trades;
identifying, in response to analyzing, revenue change drivers data in connection with the raw data corresponding to one or more trades;
decomposing revenue data by computing the revenue drivers data;
decomposing the revenue data by computing the revenue change drivers data;
generating, in response to decomposing, a custom graphical user interface (GUI) having a plurality of display screens; and
displaying an analysis report on data corresponding to the identified drivers data onto the plurality of display screens in a desired format.

20. The non-transitory computer readable medium according to claim 15, wherein the system of record is an agency securities lending system.
